(19) United States
(12) Patent Application Publication
(10) Pub. No.: US 2015/0042628 A1
(43) Pub. Date: Feb. 12, 2015

(54) Gate Driver

(71) Applicant: HannStar Display Corporation, New Taipei City (TW)

(72) Inventors: Chun-Chin TSENG, Kaohsiung City (TW); Ya-Wen LEE, Tainan City (TW); Wen-Zhe LIN, Tainan City (TW); Kuo-Wen PAN, Kaohsiung City (TW)

(73) Assignee: HannStar Display Corporation, New Taipei City (TW)

(21) Appl. No.: 14/260,274

(22) Filed: Apr. 23, 2014

(30) Foreign Application Priority Data
Aug. 6, 2013 (CN) 201310339509.4

(51) Int. Cl. G09G 3/36

(52) U.S. Cl. CPC G09G 3/3648
USPC 345/205; 345/87

(57) ABSTRACT

A gate driver is used to drive scan lines, a first scan line to a m^{th} scan line. The m is a positive integer. The gate driver comprises driver units, a first driver unit to a m^{th} driver unit, coupled with the first scan line to the m^{th} scan line respectively. The driver units generate scan signals, a first scan signal to a m^{th} scan signal, to drive the first scan line to the m^{th} scan line respectively. The first driver unit, the second driver unit, the (m−1)^{th} driver unit and the m^{th} driver unit have the same circuit structure. The third driver unit and the (m−2)^{th} driver unit have the same circuit structure. The fourth driver unit and the (m−3)^{th} driver unit have the same circuit structure.

### RELATED APPLICATIONS

This application claims priority to Chinese Application Serial Number 201310339509.4, filed Aug. 6, 2013, which is herein incorporated by reference.

### TECHNICAL FIELD

The present disclosure relates to a driver, and more particularly to a gate driver.

### BACKGROUND

With fast advance in the semiconductor technique, portable electronic devices and flat panel displays (FDPs) have been rapidly developed in recent years. Among various types of the FDPs, liquid crystal displays (LCDs) have gradually become the mainstream products for the advantages of a low operating voltage, free of harmful radiation, light weight and small and compact size and so on. As a consequence, the manufactures in the filed keep developing new fabricating methods towards miniaturation and low cost of production.

In order to lower the fabricating cost of LCDs, instead of disposing gate driver on a scan side of an LCD, parts of manufacturers directly dispose the gate driver on a glass substrate of the LCD under an amorphous silicon (a-Si) process. Hence, the gate driver originally disposed on the scan side of the LCD can be omitted so as to reduce the fabricating cost of the LCD.

### SUMMARY

The present invention discloses a gate driver that is directly disposed on a glass substrate of the LCD.

The present invention discloses a gate driver that can forward scan the scan lines and reverse scan the scan lines.

The present invention provides a gate driver. The gate driver is used to drive scan lines, a first scan line to a m^{th} scan line. The m is a positive integer. The gate driver comprises driver units, a first driver unit to a m^{th} driver unit, coupled with the first scan line to the m^{th} scan line respectively. The driver units generate scan signals, a first scan signal to a m^{th} scan signal, to drive the first scan line to the m^{th} scan line respectively. The first driver unit, the second driver unit, the (m−1)^{th} driver unit and the m^{th} driver unit have the same circuit structure. The third driver unit and the (m−2)^{th} driver unit have the same circuit structure. The fourth driver unit and the (m−3)^{th} driver unit have the same circuit structure.

In an embodiment, the gate driver further comprises a first start pulse signal, a second start pulse signal, a first clock signal, a second clock signal, a third clock signal and a fourth clock signal transferring to the gate driver units. Each of the first start pulse signal and the second start pulse signal is a pulse signal with a pulse width of T/2, and each of the first clock signal, the second clock signal, the third clock signal and the fourth clock signal has a period of T.

In an embodiment, when the gate driver is controlled to forward scan the scan lines, the first start pulse signal, the third clock signal, the fourth clock signal, the first clock signal and the second clock signal are sequentially generated. The third clock signal is generated at T/4 behind the first start pulse signal being generated, and the fourth clock signal is generated at T/4 behind the third clock signal being generated, and the first clock signal is generated at T/4 behind the fourth clock signal being generated, and the second clock signal is generated at T/4 behind the first clock signal being generated.

In an embodiment, when the gate driver is controlled to reverse scan the scan lines, the second start pulse signal, the second clock signal, the first clock signal, the fourth clock signal and the third clock signal are sequentially generated. The second clock signal is generated at T/4 behind the second start pulse signal being generated, and the first clock signal is generated at T/4 behind the second clock signal being generated, and the fourth clock signal is generated at T/4 behind the first clock signal being generated, and the third clock signal is generated at T/4 behind the fourth clock signal being generated.

In an embodiment, each of the first driver unit, the second driver unit, the (m−1)^{th} driver unit and the m^{th} driver unit further comprises a first pull-up circuit is coupled between a node and a first signal, wherein the first pull-up circuit changes a voltage level of the node according to the first signal and a second signal; a second pull-up circuit is coupled between the node and a third signal, wherein the second pull-up circuit changes a voltage level of the node according to the third signal and a fourth signal; an output circuit is coupled with a scan line and a fifth signal, wherein the output circuit outputs the fifth signal to serve as a scan signal according to the changed voltage level in the node; a first pull-down circuit is coupled between the scan line and a low-level voltage, wherein the first pull-down circuit pulls down a voltage of the scan line to the low-level voltage according to a sixth signal; and a second pull-down circuit is coupled between the node and the low-level voltage, wherein the second pull-down circuit pulls down a voltage of the node to the low-level voltage according to a seventh signal.

In an embodiment, each of the third driver unit and the (m−2)^{th} driver unit further comprises: a first pull-up circuit is coupled between a node and a first signal, wherein the first pull-up circuit changes a voltage level of the node according to the first signal and a second signal; a second pull-up circuit is coupled between the node and a third signal, wherein the second pull-up circuit changes a voltage level of the node according to the third signal and a fourth signal; an output circuit is coupled with a scan line and a fifth signal, wherein the output circuit outputs the fifth signal to serve as a scan signal according to the changed voltage level in the node; a first pull-down circuit is coupled between the scan line and a low-level voltage, wherein the first pull-down circuit pulls down a voltage of the scan line to the low-level voltage according to a sixth signal; a second pull-down circuit is coupled between the node and the low-level voltage, wherein the second pull-down circuit pulls down a voltage of the node to the low-level voltage according to a seventh signal; and a third pull-down circuit is coupled between the node and the low-level voltage, wherein the third pull-down circuit pulls down a voltage of the node to the low-level voltage according to a eighth signal.

In an embodiment, each of the fourth driver unit and the (m−3)^{th} driver unit further comprises: a first pull-up circuit is coupled between a node and a first signal, wherein the first pull-up circuit changes a voltage level of the node according to the first signal and a second signal; a second pull-up circuit is coupled between the node and a third signal, wherein the second pull-up circuit changes a voltage level of the node according to the third signal and a fourth signal; an output circuit is coupled with a scan line and a fifth signal, wherein the output circuit outputs the fifth signal to serve as a scan signal according to the changed voltage level in the node; a first pull-down circuit is coupled between the scan line and a low-level voltage, wherein the first pull-down circuit pulls down a voltage of the scan line to the low-level voltage according to a sixth signal; a second pull-down circuit is coupled between the node and the low-level voltage, wherein the second pull-down circuit pulls down a voltage of the node to the low-level voltage according to a seventh signal; a third pull-down circuit is coupled between the node and the low-level voltage, wherein the third pull-down circuit pulls down a voltage of the node to the low-level voltage according to a eighth signal; a fourth pull-down circuit is coupled between the node and the low-level voltage, wherein the fourth pull-down circuit pulls down a voltage of the node to the low-level voltage according to a ninth signal; and a fifth pull-down circuit is coupled between the node and the low-level voltage, wherein the fifth pull-down circuit pulls down a voltage of the node to the low-level voltage according to a tenth signal.

In an embodiment, the second signal is a h^{th} clock signal, wherein h=1+mod(n/4), the fourth signal is a i^{th} clock signal, wherein i=1+mod((n+2)/4), the fifth signal is a j^{th} clock signal, wherein j=1+mod((n+1)/4), the sixth signal is a k^{th} clock signal, wherein k=1+mod((n+3)/4), wherein n=1 to m.

In an embodiment, the first pull-up circuit further comprises a first switch, wherein a gate electrode and a source electrode of the first switch is connected together to receives the first signal and a drain electrode of the first switch is coupled to the node; and a second switch, wherein a source electrode of the second switch is connected to the source electrode of the first switch, a gate electrode of the second switch receives the second signal and a drain electrode of the second switch is coupled to the node.

In an embodiment, the second pull-up circuit further comprises a third switch, wherein a gate electrode and a source electrode of the third switch is connected together to receives the third signal and a drain electrode of the third switch is coupled to the node; and a fourth switch, wherein a source electrode of the fourth switch is connected to the source electrode of the third switch, a gate electrode of the fourth switch receives the fourth signal and a drain electrode of the fourth switch is coupled to the node.

In an embodiment, the output circuit further comprises a fifth switch, wherein a source electrode of the fifth switch receives the fifth signal, a gate electrode of the fifth switch is coupled with the node and a drain electrode of the fifth switch is coupled with the scan line.

In an embodiment, the first pull-down circuit further comprises a sixth switch, wherein a source electrode of the sixth switch is coupled with the scan line, a gate electrode of the sixth switch receives the sixth signal and a drain electrode of the sixth switch is coupled with the low-level voltage.

In an embodiment, the second pull-down circuit further comprises a seventh switch, wherein a source electrode of the seventh switch is coupled with the node, a gate electrode of the seventh switch receives the seventh signal and a drain electrode of the seventh switch is coupled with the low-level voltage.

In an embodiment, the third pull-down circuit further comprises an eighth switch, wherein a source electrode of the eighth switch is coupled with the node, a gate electrode of the eighth switch receives the eighth signal and a drain electrode of the eighth switch is coupled with the low-level voltage.

In an embodiment, the fourth pull-down circuit further comprises a ninth switch, wherein a source electrode of the ninth switch is coupled with the node, a gate electrode of the ninth switch receives the ninth signal and a drain electrode of the ninth switch is coupled with the low-level voltage.

In an embodiment, the fifth pull-down circuit further comprises a tenth switch, wherein a source electrode of the tenth switch is coupled with the node, a gate electrode of the tenth switch receives the tenth signal and a drain electrode of the tenth switch is coupled with the low-level voltage.

Accordingly, the gate driver receives four clock signals that are triggered in different times to forward or reverse scan the scan lines to reach the bi-scanning effect.

### BRIEF DESCRIPTION OF THE DRAWINGS

In order to make the foregoing as well as other aspects, features, advantages, and embodiments of the present disclosure more apparent, the accompanying drawings are described as follows:

FIG. 1 is a schematic diagram of a liquid crystal panel in accordance with an embodiment of the present invention.

FIG. 2A illustrates time schemes of control signals for controlling the gate driver to forward scan the scan lines in accordance with an embodiment of the present invention.

FIG. 2B illustrates time schemes of control signals for controlling the gate driver to reverse scan the scan lines in accordance with an embodiment of the present invention.

FIG. 3A illustrates a schematic diagram of the first gate driver unit in accordance with another embodiment of the present invention.

FIG. 3B illustrates a schematic diagram of the second gate driver unit in accordance with another embodiment of the present invention.

FIG. 3C illustrates a schematic diagram of the (m−1)^{th} gate driver unit in accordance with another embodiment of the present invention.

FIG. 3D illustrates a schematic diagram of the m^{th} gate driver unit in accordance with another embodiment of the present invention.

FIG. 4A illustrates a schematic diagram of the third gate driver unit in accordance with another embodiment of the present invention.

FIG. 4B illustrates a schematic diagram of the (m−2)^{th} gate driver unit in accordance with another embodiment of the present invention.

FIG. 5A illustrates a schematic diagram of the fourth gate driver unit in accordance with another embodiment of the present invention.

FIG. 5B illustrates a schematic diagram of the fifth gate driver unit in accordance with another embodiment of the present invention.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

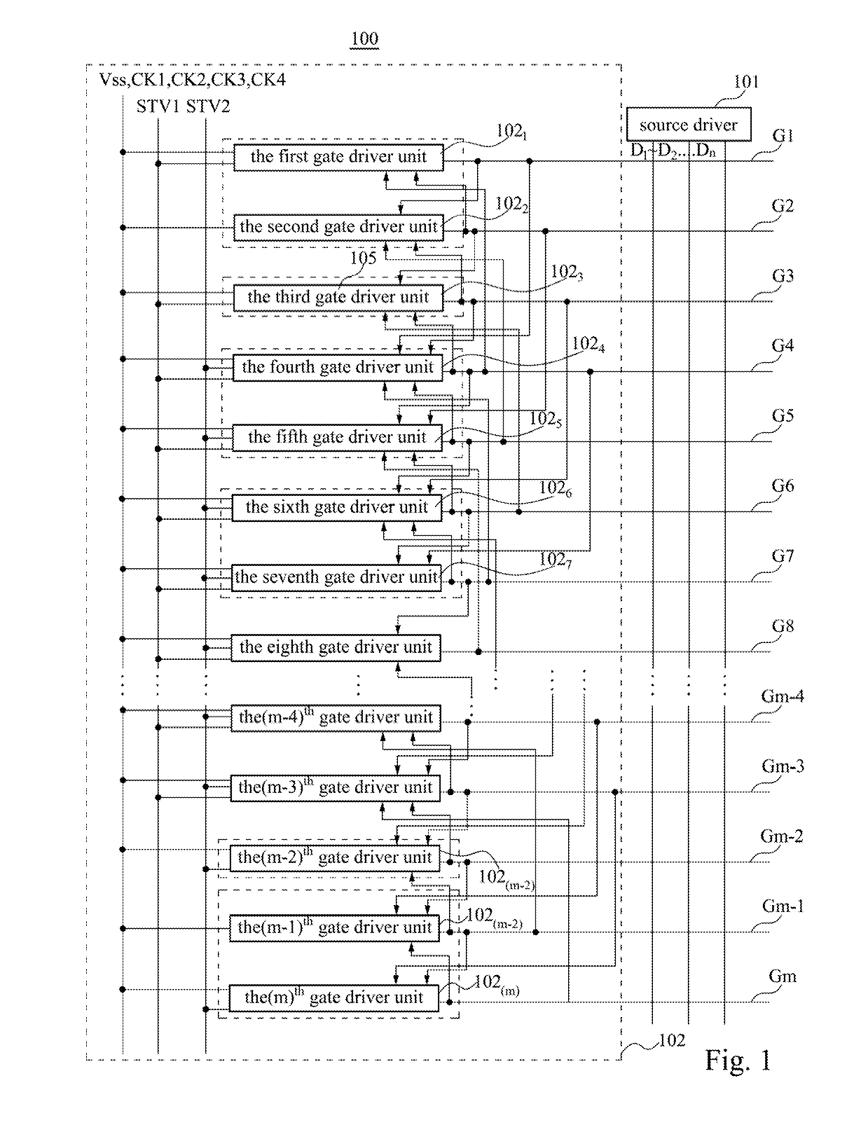

FIG. 1 is a schematic diagram of a liquid crystal panel in accordance with an embodiment of the present invention. The liquid crystal panel 100 includes a plurality of data lines D1, D2 . . . Dn, a plurality of scan lines G1, G2 . . . Gm, a source driver 101 and a gate driver 102. The source driver 101 is used to drive the data lines D1, D2 . . . Dn. The gate driver 102 is used to drive the scan lines G1, G2 . . . Gm. The gate driver 102 further includes m number of gate driver units, the first gate driver unit 102₁, the second gate driver unit 102₂, . . . , the m^{th} gate driver unit 102ₘ. Each of the gate driver units drives a corresponding scan line. For example, the first gate driver unit 102₁ drives the scan line G1, the second gate driver unit 102₂ drives the scan line G2 and the m^{th} gate driver unit 102ₘ drives the m^{th} scan line. The rest may be deduced by analogy. The control signals of the first start pulse signal STV1, the second start pulse signal STV2, the first clock signal CK1, the second clock signal CK2, the third clock signal CK3, the fourth clock signal CK4 and the fifth clock signal CK5 are used to drive the m number of gate driver units. The first gate driver unit 102₁, the second gate driver unit 102₂, the (m−1)^{th} gate driver unit 102ₘ₋₁ and the m^{th} gate driver unit 102ₘ have the same circuit structure. The third gate driver unit 102₃ and the (m−2)^{th} gate driver unit 102ₘ₋₂ have the same circuit structure. The fourth gate driver unit 102₄ to the (m−3)^{th} gate driver unit 102ₘ₋₃ have the same circuit structure. The time schemes of the control signals transferred to the gate drivers with same circuit structure are different to make the m number of gate driver units generate scan signals respectively.

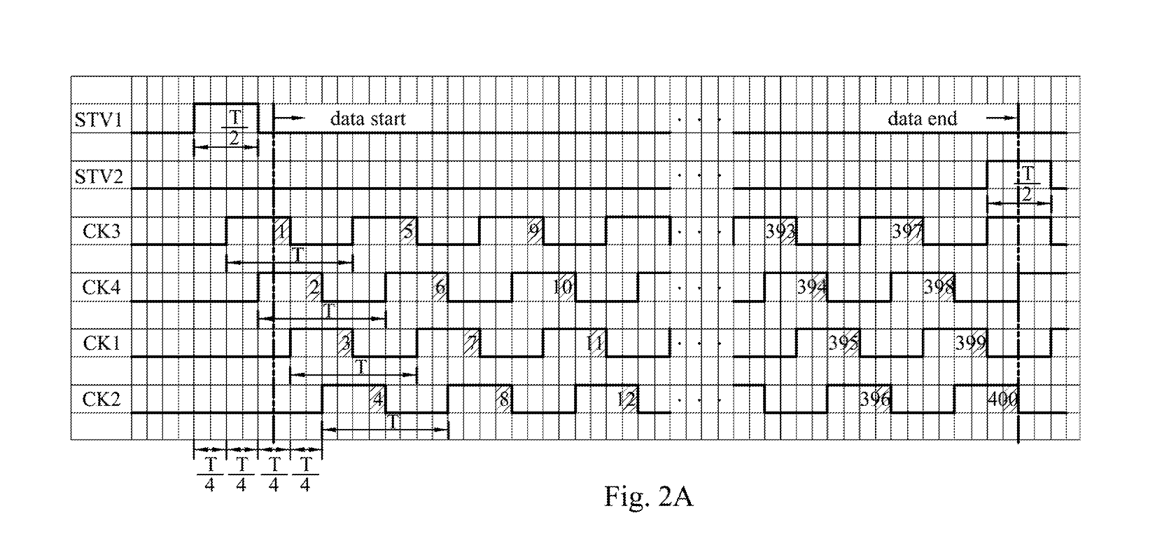

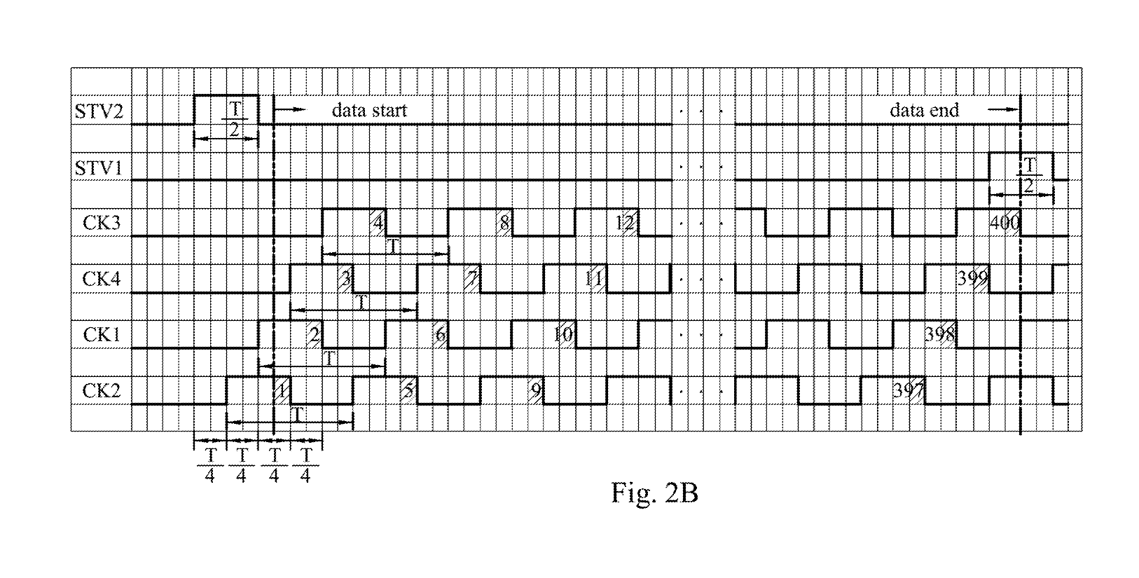

FIG. 2A illustrates time schemes of control signals for controlling the gate driver to forward scan the scan lines. When control signals drive the gate driver 102 to forward scan the scan lines, the first start pulse signal STV1, the third clock signal CK3, the fourth clock signal CK4, the first clock signal CK1 and the second clock signal CK2 are generated sequentially and overlap to each other. The first start pulse signal STV1 is a pulse signal with a signal width of T/2. Each of the third clock signal CK3, the fourth clock signal CK4, the first clock signal CK1 and the second clock signal CK2 has a period of T. The first start pulse signal STV1 is generated. Then, the third clock signal CK3 is generated at T/4 signal width behind the first start pulse signal STV1 being generated. The fourth clock signal CK4 is generated at T/4 signal width behind the third clock signal CK3 being generated. The first clock signal CK1 is generated at T/4 signal width behind the fourth clock signal CK4 being generated. The second clock signal CK2 is generated at T/4 signal width behind the first clock signal CK1 being generated. Accordingly, after the first start pulse signal STV1 is generated, the third clock signal CK3, the fourth clock signal CK4, the first clock signal CK1 and the second clock signal CK2 are sequentially transferred to the m number of the gate driver units 102₁-102ₘ in the gate driver 102. Then, the gate driver units 102₁-102ₘ sequentially generate scan signals SG1-SGm to the scan lines G1-Gm to perform a forward scanning process.

In an embodiment, the generation of the scan signal SG1 synchronizes with the generation of the high level signal in the first period of the third clock signal CK3. The generation of the scan signal SG2 synchronizes with the generation of the high level signal in the first period of the fourth clock signal CK4. The generation of the scan signal SG3 synchronizes with the generation of the high level signal in the first period of the first clock signal CK1. The generation of the scan signal SG4 synchronizes with the generation of the high level signal in the first period of the second clock signal CK2. The generation of the scan signal SG5 synchronizes with the generation of the high level signal in the second period of the third clock signal CK3. The generation of the scan signal SG6 synchronizes with the generation of the high level signal in the second period of the fourth clock signal CK4. The rest may be deduced by analogy. After all the scan lines G1-Gm is scanned, the second start pulse signal STV2 is triggered.

FIG. 2B illustrates time schemes of control signals for controlling the gate driver to reverse scan the scan lines. When control signals drive the gate driver 102 to reverse scan the scan lines, the second start pulse signal STV2, the second clock signal CK2, the first clock signal CK1, the fourth clock signal CK4 and the third clock signal CK3 are generated sequentially and overlap to each other. The second start pulse signal STV2 is generated. Then, the second clock signal CK2 is generated at T/4 signal width behind the second start pulse signal STV2 being generated. The first clock signal CK1 is generated at T/4 signal width behind the second clock signal CK2 being generated. The fourth clock signal CK4 is generated at T/4 signal width behind the first clock signal CK1 being generated. The third clock signal CK3 is generated at T/4 signal width behind the fourth clock signal CK4 being generated. Accordingly, after the second start pulse signal STV2 is generated, the second clock signal CK2, the first clock signal CK1, the fourth clock signal CK4 and the third clock signal CK3 are sequentially transferred to the m number of the gate driver units 102₁-102ₘ in the gate driver 102. Then, the gate driver units 102₁-102ₘ sequentially generate scan signals SGm-SG1 to the scan lines Gm-G1 to perform a reverse scanning process.

In an embodiment, the generation of the scan signal SGm synchronizes with the generation of the high level signal in the first period of the second clock signal CK2. The generation of the scan signal SG(m−1) synchronizes with the generation of the high level signal in the first period of the first clock signal CK1. The generation of the scan signal SG(m−2) synchronizes with the generation of the high level signal in the first period of the fourth clock signal CK4. The generation of the scan signal SG(m−3) synchronizes with the generation of the high level signal in the first period of the third clock signal CK3. The generation of the scan signal SG(m−4) synchronizes with the generation of the high level signal in the second period of the second clock signal CK2. The generation of the scan signal SG(m−5) synchronizes with the generation of the high level signal in the second period of the first clock signal CK1. The rest may be deduced by analogy. After all the scan lines Gm-G1 is scanned, the first start pulse signal STV1 is triggered again.

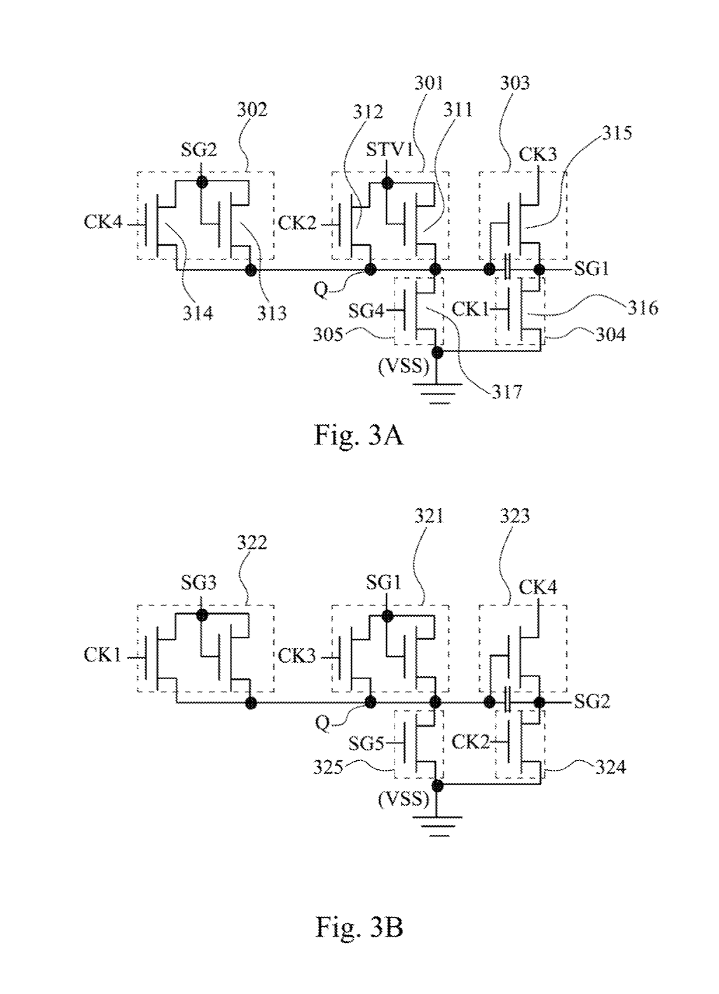

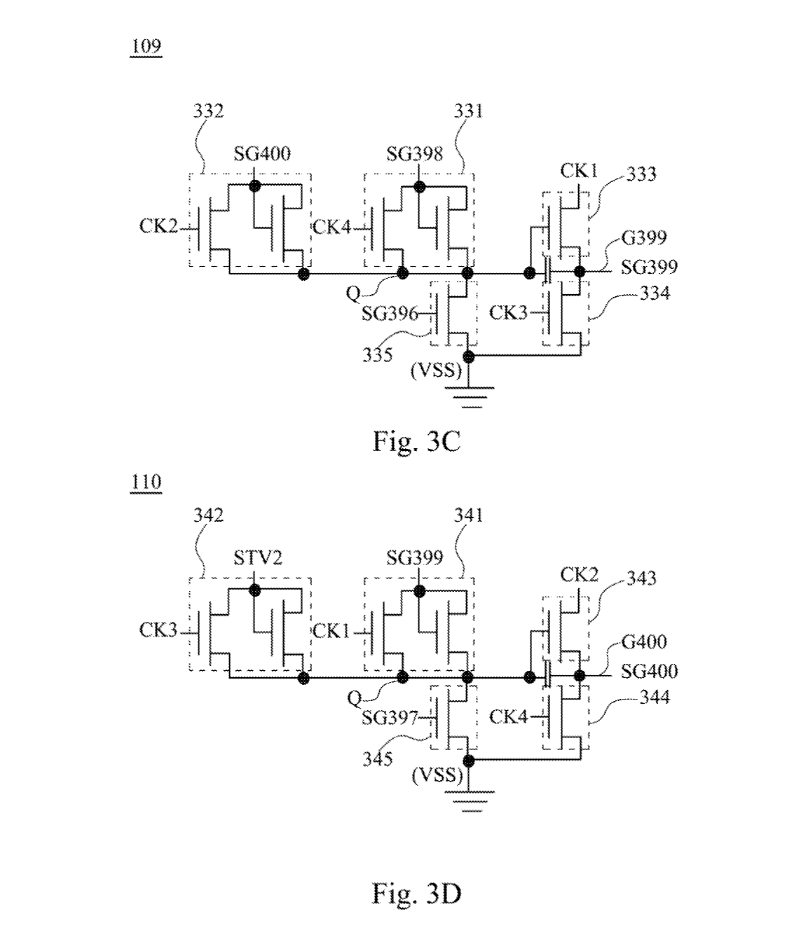

FIG. 3A illustrates a schematic diagram of the first gate driver unit 102₁. The first gate driver units 102₁ includes a first pull-up circuit 301, a second pull-up circuit 302, an output circuit 303, a first pull-down circuit 304 and a second pull-down circuit 305. The first pull-up circuit 301 is coupled with a node Q to receive a first start pulse signal STV1 to pull up the voltage level in node Q and to release the accumulated charge in node Q according to the second clock signal CK2. The second pull-up circuit 302 is coupled with the node Q to receive the scan signal SG2 from the next stage driver unit, the second gate driver unit 102₂, to keep the voltage level in node Q. When the first gate driver unit 102₁ is operated according the time scheme of time schemes of control signals in FIG. 2A, the first pull-up circuit 301 is the main unit to pull up the voltage level in node Q. In contrast, when the first gate driver unit 102₁ is operated according the time scheme of time schemes of control signals in FIG. 2B, the second pull-up circuit 302 is the main unit to pull up the voltage level in node Q. The output circuit 303 is coupled with the scan line G1 to receive the third clock signal CK3. The output circuit 303 outputs the third clock signal CK3 to the scan line G1 according to the voltage level in node Q to serve as the scan signal SG1. The first pull-down circuit 304 pulls down the scan signal SG1 according to the first clock signal CK1. The second pull-down circuit 305 pulls down the voltage level in node Q to release the accumulated charge according to the scan signal SG4 outputted by the gate driver unit 102₄.

The first pull-up circuit 301 includes a first switch 311 and a second switch 312. The gate electrode of the first switch 311 is coupled with the source electrode of the first switch 311 to receive the first start pulse signal STV1. The drain electrode of the first switch 311 is coupled with the node Q. The source electrode of the second switch 312 is coupled with the source electrode of the first switch 311. The gate electrode of the second switch 312 receives the second clock signal CK2. The drain electrode of the second switch 312 is coupled with the node Q. When the first start pulse signal STV1 is generated, the high-level first start pulse signal STV1 turns on the first switch 311 to pull up the voltage level in node Q.

The second pull-up circuit 302 includes a third switch 313 and a fourth switch 314. The gate electrode of the third switch 313 is coupled with the source electrode of the third switch 313 to receive the scan signal SG2 from the gate driver unit 102₂. The drain electrode of the third switch 313 is coupled with the node Q. The source electrode of the third switch 313 is coupled with the source electrode of the fourth switch 314. The gate electrode of the fourth switch 314 receives the fourth clock signal CK4. The drain electrode of the fourth switch 314 is coupled with the node Q. The high-level signal in the first period of the fourth clock signal CK4 synchronizes with the scan signal SG2. Therefore, when the scan signal SG2 turns on the third switch 313, the fourth clock signal CK4 also turns on the fourth switch 314 to use the scan signal SG2 to keep the voltage level in node Q.

The output circuit 303 includes a fifth switch 315. The source electrode of the fifth switch 315 receives the third clock signal CK3. The gate electrode of the fifth switch 315 is coupled with the node Q. The drain electrode of the fifth switch 315 is coupled with the scan line G1. When the voltage level in node Q turns on the fifth switch 315, the third clock signal CK3 is outputted to the scan line G1 to serve as the scan signal SG1.

The first pull-down circuit 304 includes a sixth switch 316. The source electrode of the sixth switch 316 is coupled with the scan line G1. The gate electrode of the sixth switch 316 receives the first clock signal CK1. The drain electrode of the sixth switch 316 is coupled with the ground or the voltage Vss. When the first clock signal CK1 turns on the sixth switch 316, the voltage in scan line G1 is pulled down to make the voltage level be equal to the voltage level of ground or Vss.

The second pull-down circuit 305 includes a seventh switch 317. The source electrode of the seventh switch 317 is coupled with the node Q. The gate electrode of the seventh switch 317 receives the scan signal SG4 from the gate driver unit 102₄. The drain electrode of the seventh switch 317 is coupled with the ground or the voltage Vss. The high-level signal in the first period of the second clock signal CK2 synchronizes with the scan signal SG4. Therefore, when the scan signal SG4 turns on the seventh switch 317, the second clock signal CK2 also turns on the second switch 312. At this time, the first start pulse signal STV1 is in a low-level state. Therefore, the accumulated charge in node Q is released through the second switch 312 and the seventh switch 317.

Accordingly, when the gate driver 102 is controlled to forward scan the scan lines, the gate driver unit 102₁ is driven first. That is, the first start pulse signal STV1, the third clock signal CK3, the fourth clock signal CK4, the first clock signal CK1 and the second clock signal CK2 are sequentially transferred to the gate driver unit 102₁. Please refer to the FIG. 2A and FIG. 3A. The first pull-up circuit 301 receives the first start pulse signal STV1 to pull up the voltage level in node Q. Next, the third clock signal CK3 is transferred to the output circuit 303. The third clock signal CK3 is outputted form the output circuit 303 to the scan line G1 to serve as the scan signal SG1 according to the pulled up voltage level in node Q. The scan signal SG1 is also transferred to the gate driver unit 102₂. Then, the fourth clock signal CK4 and the scan signal SG2 are transferred to the second pull-up circuit 302. While the scan signal SG2 is in a high-level state, the scan signal SG2 is transferred to the node Q to keep the voltage level in node Q. Next, the second clock signal CK2 and the scan signal SG4 are transferred to the first pull-up circuit 301 and the second pull-down circuit 305 respectively. Because the first start pulse signal STV1 has been pulled down, the node Q is coupled to a low-level voltage state to release the accumulated charge. Finally, the first clock signal CK1 is transferred to the first pull-down circuit 304 to pull down the scan signal SG1.

On the other hand, when the gate driver 102 is controlled to reverse scan the scan lines, the gate driver unit 102₁ is driven last. That is, the second clock signal CK2, the first clock signal CK1, the fourth clock signal CK4, the third clock signal CK3 and the first start pulse signal STV1 are sequentially transferred to the gate driver unit 102₁. Please refer to the FIG. 2B and FIG. 3A. First, the second clock signal CK2 and the scan signal SG4 are transferred to the first pull-up circuit 301 and the second pull-down circuit 305 respectively. Because the first start pulse signal STV1 is in a low-level state, the node Q is coupled to a low-level voltage state to release the accumulated charge. Next, the first clock signal CK1 is transferred to the first pull-down circuit 304 to keep the scan signal SG1 in a low-level state. Then, the fourth clock signal CK4 and the scan signal SG2 are transferred to the second pull-up circuit 302 to output the scan signal SG2 to the node Q to keep the node Q in a high-level state. The third clock signal CK3 is transferred to the output circuit 303. The third clock signal CK3 is outputted form the output circuit 303 to the scan line G1 to serve as the scan signal SG1 according to the pulled up voltage level in node Q. The scan signal SG1 is also transferred to the gate driver unit 102₂. Accordingly, the first scan signal SG1 is generated when the gate driver 102 is controlled to reverse scan the scan lines. In other words, when the gate driver 102 is controlled to forward scan the scan lines, the first pull-up circuit 301 is triggered to pull up the voltage-level in node Q, then, the second pull-up circuit 302 is triggered to keep the node Q in a high-level state. In contrast, when the gate driver 102 is controlled to reverse scan the scan lines, the second pull-up circuit 302 is triggered to pull up the voltage-level in node Q, then, the first pull-up circuit 301 is triggered to keep the node Q in a high-level state.

The gate driver unit 102₂ and the gate driver unit 102₁ have the same circuit structure. However, the clock signals transferred to the gate driver unit 102₂ are different from that transferred to the gate driver unit 102₁. According to the invention, when the gate driver 102 is controlled to forward scan the scan lines, the third clock signal CK3, the fourth clock signal CK4, the first clock signal CK1 and the second clock signal CK2 are sequentially transferred to the gate driver 102 to make the gate driver 102 generates the scan signals according to the order of the third clock signal CK3, the fourth clock signal CK4, the first clock signal CK1 and the second clock signal CK2. In contrast, when the gate driver 102 is controlled to reverse scan the scan lines, the second clock signal CK2, the first clock signal CK1, the fourth clock signal CK4, the third clock signal CK3 are sequentially transferred to the gate driver 102 to make the gate driver 102 generates the scan signals according to the order of the second clock signal CK2, the first clock signal CK1, the fourth clock signal CK4, the third clock signal CK3. Therefore, if a circuit in the first gate driver unit 102₁ is used to receive the third clock signal CK3, this circuit in the second gate driver unit 102₂ is used to receive the fourth clock signal CK4, this circuit in the third gate driver unit 102₃ is used to receive the first clock signal CK1, this circuit in the fourth gate driver unit 102₄ is used to receive the second clock signal CK2 and this circuit in the fifth gate driver unit 102₅ is used to receive the third clock signal CK3. The rest may be deduced by analogy. In other words, the third clock signal CK3, the fourth clock signal CK4, the first clock signal CK1 and the second clock signal CK2 are transferred to the same circuit of the gate driver units receives sequentially.

In an embodiment, the first pull-up circuit 301 in the first gate driver unit 102₁ is used to receive the second clock signal CK2, this first pull-up circuit in the second gate driver unit 102₂ is used to receive the third clock signal CK3, this first pull-up circuit in the third gate driver unit 102₃ is used to receive the fourth clock signal CK4, and this first pull-up circuit in the fourth gate driver unit 102₄ is used to receive the first clock signal CK1. In other words, the clock signal transferred to the first pull-up circuit in the gate driver units is the h^{th} clock signal, wherein h=1+mod(n/4), n=1, 2, . . . , m.

The second pull-up circuit 302 in the first gate driver unit 102₁ is used to receive the fourth clock signal CK4, this second pull-up circuit in the second gate driver unit 102₂ is used to receive the first clock signal CK1, this second pull-up circuit in the third gate driver unit 102₃ is used to receive the second clock signal CK2, and this second pull-up circuit in the fourth gate driver unit 102₄ is used to receive the third clock signal CK3. In other words, the clock signal transferred to the second pull-up circuit in the gate driver units is the i^{th} clock signal, wherein i=1+mod((n+2)/4), n=1, 2, . . . , m.

The output circuit 303 in the first gate driver unit 102₁ is used to receive the third clock signal CK3, this output circuit in the second gate driver unit 102₂ is used to receive the fourth clock signal CK4, this output circuit in the third gate driver unit 102₃ is used to receive the first clock signal CK1, and this output circuit in the fourth gate driver unit 102₄ is used to receive the second clock signal CK2. In other words, the clock signal transferred to the output circuit in the gate driver units is the j^{th} clock signal, wherein j=1+mod((n+1)/4), n=1, 2, . . . , m.

The first pull-down circuit 304 in the first gate driver unit 102₁ is used to receive the first clock signal CK1, this first pull-down circuit in the second gate driver unit 102₂ is used to receive the second clock signal CK2, this first pull-down circuit in the third gate driver unit 102₃ is used to receive the third clock signal CK3, and this first pull-down circuit in the fourth gate driver unit 102₄ is used to receive the fourth clock signal CK4. In other words, the clock signal transferred to the first pull-down circuit in the gate driver units is the k^{th} clock signal, wherein k=1+mod((n+3)/4), n=1, 2, . . . , m.

Moreover, when the gate driver 102 is controlled to forward scan the scan lines, the scan signal generated by the present gate driver unit is transferred to the first gate driver after the present gate driver unit to pull up the voltage level in node Q, and is transferred to the third gate driver unit after the present gate driver unit to release the accumulated charge in the node Q. When the gate driver 102 is controlled to reverse scan the scan lines, the scan signal generated by the present gate driver unit is transferred to the first gate driver before the present gate driver unit to pull up the voltage level in node Q, and is transferred to the third gate driver unit before the present gate driver unit to release the accumulated charge in the node Q.

FIG. 3B illustrates a schematic diagram of the second gate driver unit 102₂. The second gate driver unit 102₂ and the first gate driver units 102₁ have same circuit structure. The second gate driver unit 102₂ includes a first pull-up circuit 321, a second pull-up circuit 322, an output circuit 323, a first pull-down circuit 324 and a second pull-down circuit 325. The first pull-up circuit 321 is coupled with a node Q to receive the first scan signal SG1 from the first gate driver units 102₁ to keep or pull up the voltage level in node Q and to release the accumulated charge in node Q according to the third clock signal CK3. The second pull-up circuit 322 is coupled with the node Q to receive the scan signal SG3 from the next stage driver unit, the third gate driver unit 102₃, to keep the voltage level in node Q. When the second gate driver unit 102₂ is operated according the time scheme of time schemes of control signals in FIG. 2A, the first pull-up circuit 321 is the main unit to pull up the voltage level in node Q. In contrast, when the second gate driver unit 102₂ is operated according the time scheme of time schemes of control signals in FIG. 2B, the second pull-up circuit 322 is the main unit to pull up the voltage level in node Q. The output circuit 323 is coupled with the scan line G2 to receive the fourth clock signal CK4. The output circuit 323 outputs the fourth clock signal CK4 to the scan line G2 according to the voltage level in node Q to serve as the scan signal SG2. The first pull-down circuit 324 pulls down the scan signal SG2 according to the second clock signal CK2. The second pull-down circuit 325 pulls down the voltage level in node Q to release the accumulated charge according to the scan signal SG5 outputted by the gate driver unit 102₅. Accordingly, the second pull-up circuit 302 in the first gate driver unit 102₁ is used to receive the scan signal SG2 to keep the voltage level in node Q, this second pull-up circuit 322 in the second gate driver unit 102₂ is used to receive the scan signal SG3 to keep the voltage level in node Q. The rest may be deduced by analogy. The operation method of the first gate driver unit 102₁ is same as that of the second gate driver unit 102₂.

FIG. 3C illustrates a schematic diagram of the (m−1)^{th} gate driver unit 102₍ₘ₋₁₎. The (m−1)^{th} gate driver unit 102₍ₘ₋₁₎ and the first gate driver units 102₁ have the same circuit structure. The (m−1)^{th} gate driver unit 102₍ₘ₋₁₎ includes a first pull-up circuit 331, a second pull-up circuit 332, an output circuit 333, a first pull-down circuit 334 and a second pull-down circuit 335. In an embodiment, a panel has 400 scan lines. That is, the m is equal to 400. Therefore, the (m−1)^{th} gate driver unit 102₍ₘ₋₁₎ is used to generate the scan signal SG399 to drive the 399^{th} scan line G399. Accordingly, the first pull-up circuit 331 is coupled with a node Q to receive the scan signal SG398 from the 398^{th} gate driver units 102₃₉₈ to keep or pull up the voltage level in node Q and to release the accumulated charge in node Q according to the fourth clock signal CK4. The second pull-up circuit 332 is coupled with the node Q to receive the scan signal SG400 from the next gate driver unit, the 400^{th} gate driver unit 102₄₀₀, and the second clock signal CK2 to keep the voltage level in node Q. The output circuit 333 is coupled with the scan line G399 to receive the first clock signal CK1. The output circuit 333 outputs the first clock signal CK1 to the scan line G399 according to the voltage level in node Q to serve as the scan signal SG399. The first pull-down circuit 334 pulls down the scan signal SG399 according to the third clock signal CK3. The second pull-down circuit 335 pulls down the voltage level in node Q to release the accumulated charge according to the scan signal SG396 outputted by the 396^{th} gate driver unit 102₃₉₆.

FIG. 3D illustrates a schematic diagram of the m^{th} gate driver unit 102ₘ. The m^{th} gate driver unit 102ₘ and the first gate driver units 102₁ have the same circuit structure. The m^{th} gate driver unit 102ₘ includes a first pull-up circuit 341, a second pull-up circuit 342, an output circuit 343, a first pull-down circuit 344 and a second pull-down circuit 345. In the embodiment, the m is equal to 400. Therefore, the m^{th} gate driver unit 102ₘ is used to generate the scan signal SG400 to drive the 400^{th} scan line G400. Accordingly, the first pull-up circuit 341 is coupled with a node Q to receive the scan signal SG399 from the 399^{th} gate driver units 102₃₉₉ to keep or pull up the voltage level in node Q and to release the accumulated charge in node Q according to the first clock signal CK1. The second pull-up circuit 342 is coupled with the node Q. Because the m^{th} gate driver unit 102ₘ is the first gate driver unit to be driven during reverse scanning, the second pull-up circuit 342 receives the second start pulse signal STV2 to pull up the voltage level in node Q. The output circuit 343 is coupled with the scan line G400 to receive the second clock signal CK2. The output circuit 343 outputs the second clock signal CK2 to the scan line G400 according to the voltage level in node Q to serve as the scan signal SG400. The first pull-down circuit 344 pulls down the scan signal SG400 according to the fourth clock signal CK4. The second pull-down circuit 345 pulls down the voltage level in node Q to release the accumulated charge according to the scan signal SG397 outputted by the 397^{th} gate driver unit 102₃₉₇.

It is noticed that the m^{th} gate driver unit 102ₘ is the last gate driver unit to be driven during forward scanning. Therefore, after the m^{th} gate driver unit 102ₘ is driven, the second start pulse signal STV2 is triggered. That is, the third clock signal CK3, the fourth clock signal CK4, the first clock signal CK1, the second clock signal CK2 and the second start pulse signal STV2 are sequentially transferred to the m^{th} gate driver unit 102ₘ. Please refer to the FIG. 2A and FIG. 3D. The third clock signal CK3 is transferred to the second pull-up circuit 342. Because the second start pulse signal STV2 is in a low level state, the node Q is coupled to a low level to release the accumulated charge. Next, the fourth clock signal CK4 is transferred t0 the first pull-down circuit 344 to keep the scan line G400 in a low-level state. Then, the first clock signal CK1 and the scan signal SG399 are transferred to the first pull-up circuit 341 to output the scan signal SG399 to pull up the voltage level in the node Q. The second clock signal CK2 is transferred to the output circuit 343. The output circuit 343 outputs the second clock signal CK2 to the scan line G400 to serve as the scan signal SG400 according to the pulled up voltage level in node Q. Accordingly, the forward scanning process is finished.

The m^{th} gate driver unit 102ₘ is the first gate driver unit to be driven during reverse scanning. Therefore, the second start pulse signal STV2, the second clock signal CK2, the first clock signal CK1, the fourth clock signal CK4 and the third clock signal CK3 are sequentially transferred to the m^{th} gate driver unit 102ₘ. Please refer to the FIG. 2B and FIG. 3D. First, the second start pulse signal STV2 is transferred to the second pull-up circuit 342 to pull up the voltage level in node Q. Next, the second clock signal CK2 is transferred to the output circuit 343. The output circuit 343 outputs the second clock signal CK2 to the scan line G400 to serve as the scan signal SG400 according the pulled up voltage level in the node Q. The scan signal SG 400 is also transferred to the (m−1)^{th} gate driver unit 102₍ₘ₋₁₎. Next, the first clock signal CK1 and the scan signal SG399 are transferred to the first pull-up circuit 341. The scan signal SG399 is transferred to the node Q to keep the voltage level in node Q. The fourth clock signal CK4 is transferred to the first pull-down circuit 344 to pull down the scan signal SG400. Finally, the third clock signal CK3 is transferred to the second pull-up circuit 342. Because the second start pulse signal STV2 has been in a low-level state at this time, the node Q is coupled to the ground to release the accumulated charge. Accordingly, the first scan signal SG400 in reverse scanning process is generated. The operation method of the (m−1)^{th} gate driver unit 102₍ₘ₋₁₎ is similar to the operation method of the m^{th} gate driver unit 102ₘ.

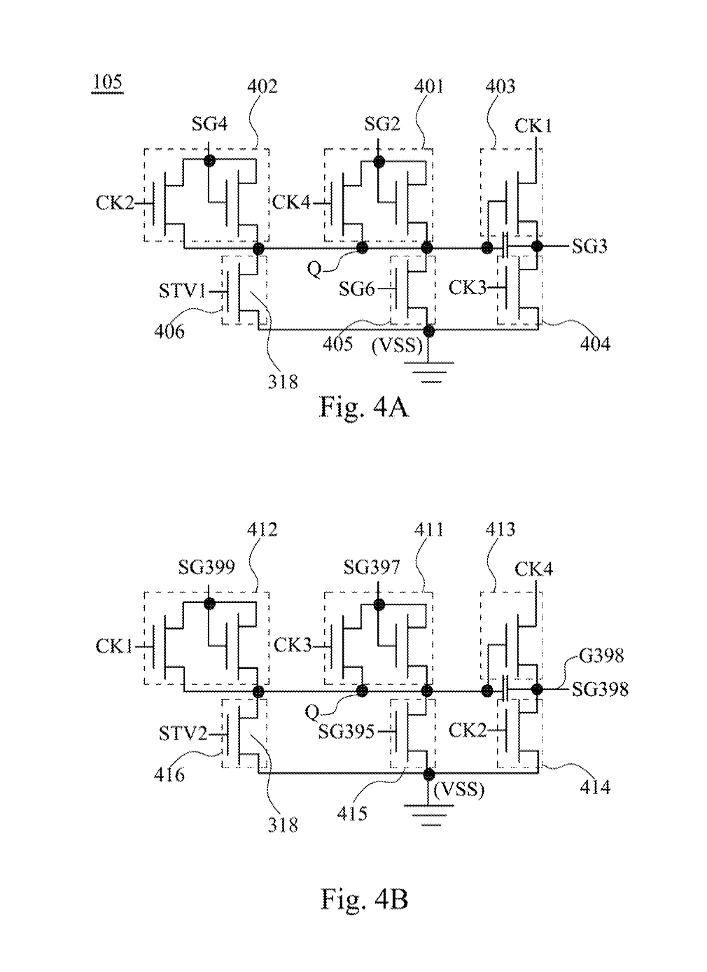

FIG. 4A illustrates a schematic diagram of the third gate driver unit 102₃. The third gate driver units 102₃ includes a first pull-up circuit 401, a second pull-up circuit 402, an output circuit 403, a first pull-down circuit 404, a second pull-down circuit 405 and a third pull-down circuit 406. The circuit structures of the first pull-up circuit 401, the second pull-up circuit 402, the output circuit 403, the first pull-down circuit 404 and the second pull-down circuit 405 in the third gate driver unit 102₃ are same as that of the first pull-up circuit 301, the second pull-up circuit 302, the output circuit 303, the first pull-down circuit 304 and the second pull-down circuit 305 in the first gate driver unit 102₁ respectively. The main different point is that the third gate driver units 102₃ further includes the third pull-down circuit 406 to receive the first start pulse signal STV1 to pull down the voltage level in node Q to release the accumulated charge before the scan signal SG3 is generated. The third pull-down circuit 406 includes a eighth switch 318. The source electrode of the eighth switch 318 is coupled with the node Q. The gate electrode of the eighth switch 318 receives the first start pulse signal STV1. The drain electrode of the eighth switch 318 is coupled with the ground or the voltage Vss. When the first start pulse signal STV1 turns on the eighth switch 318, the accumulated charge is released through the eighth switch 318.

The first pull-up circuit 401 is coupled with a node Q to receive a scan signal SG2 from the second gate driver unit 102₂ to pull up the voltage level in node Q. The second pull-up circuit 402 is coupled with the node Q to receive the scan signal SG4 from the next stage gate driver unit to keep the voltage level in node Q. The output circuit 403 is coupled with the scan line G3 to receive the first clock signal CK1. The output circuit 403 outputs the first clock signal CK1 to the scan line G3 according to the voltage level in node Q to serve as the scan signal SG3. The first pull-down circuit 404 pulls down the scan signal SG3 according to the third clock signal CK3. The second pull-down circuit 405 pulls down the voltage level in node Q to release the accumulated charge according to the scan signal SG6 outputted by the gate driver unit 102₆. The third pull-down circuit 406 pulls down the voltage level in node Q to release the accumulated charge according to the first start pulse signal STV1 before the third gate driver unit 102₃ is driven.

Accordingly, when the gate driver 102 is controlled to forward scan the scan lines, please refer to FIG. 2A and FIG. 4A, the first start pulse signal STV1, the third clock signal CK3, the fourth clock signal CK4, the first clock signal CK1 and the second clock signal CK2 are sequentially transferred to the third gate driver unit 102₃. The third pull-down circuit 406 receives the first start pulse signal STV1 to pull down the voltage level in node Q to release the accumulated charge before the third gate driver unit 102₃ is driven. Next, the third clock signal CK3 is transferred to the first pull-down circuit 404 to pull down the scan signal SG3 to prevent a mistake operation of the panel. The first pull-up circuit 401 receives the scan signal SG2 from the previous gate driver unit to pull up the voltage level in node Q. Then, the first clock signal CK1 is transferred to the output circuit 403. The first clock signal CK1 is outputted form the output circuit 403 to the scan line G3 to serve as the scan signal SG3 according to the pulled up voltage level in node Q. The scan signal SG3 is also transferred to the gate driver unit 102₄. Then, the fourth clock signal CK4 and the scan signal SG4 are transferred to the second pull-up circuit 402. The scan signal SG4 is transferred to the node Q to keep the voltage level in node Q. Finally, the scan signal SG6 is transferred to the second pull-down circuit 405 to release the accumulated charge in node Q.

On the other hand, when the gate driver 102 is controlled to reverse scan the scan lines, the second clock signal CK2, the first clock signal CK1, the fourth clock signal CK4, the third clock signal CK3 and the first start pulse signal STV1 are sequentially transferred to the gate driver unit 102₃. Please refer to the FIG. 2B and FIG. 4A. First, the first start pulse signal STV1 is in a low level state. Therefore, the third pull-down circuit 406 is not in an operation state. The scan signal SG6 is transferred to the second pull-down circuit 405 to pull down the voltage level in node Q before the gate driver unit 102₃ is driven. Next, the second clock signal CK2 and the scan signal SG4 are transferred to the second pull-up circuit 402. The second pull-up circuit 402 transfers the scan signal SG4 to the node Q to pull up the voltage level in node Q. Next, the first clock signal CK1 is transferred to the output circuit 403. The first clock signal CK1 is outputted form the output circuit 403 to the scan line G3 to serve as the scan signal SG3 according to the pulled up voltage level in node Q. The first pull-up circuit 401 receives the scan signal SG2 to keep the voltage level in node Q, Finally, the third clock signal CK3 is transferred to the first pull-down circuit 404 to pull down the scan signal SG3.

FIG. 4B illustrates a schematic diagram of the (m−2)^{th} gate driver unit 102ₘ₋₂. The (m−2)^{th} gate driver unit 102ₘ₋₂ and the third gate driver units 102₃ have the same circuit structure. The (m−2)^{th} gate driver unit 102ₘ₋₂ is used to generate the scan signal SG398 to drive the 398^{th} scan line G398. The (m−2)^{th} gate driver unit 102ₘ₋₂ includes a first pull-up circuit 411, a second pull-up circuit 412, an output circuit 413, a first pull-down circuit 414, a second pull-down circuit 415 and a third pull-down circuit 416. In the embodiment, the first pull-up circuit 411 is coupled with a node Q to receive the scan signal SG397 from the 397^{th} gate driver units 102₃₉₇ to pull up the voltage level in node Q. The second pull-up circuit 412 is coupled with the node Q to receive the scan signal SG399 to keep the voltage level in node Q. The output circuit 403 is coupled with the scan line G398 to receive the fourth clock signal CK4. The output circuit 343 outputs the fourth clock signal CK4 to the scan line G398 according to the voltage level in node Q to serve as the scan signal SG398. The first pull-down circuit 414 pulls down the scan signal SG398 according to the second clock signal CK2. The second pull-down circuit 415 pulls down the voltage level in node Q to release the accumulated charge according to the scan signal SG395 outputted by the 395^{th} gate driver unit 102₃₉₅. It is noticed that the (m−2)^{th} gate driver unit 102ₘ₋₂ is the third gate driver unit to be driven during reverse scanning. Therefore, the third pull-down circuit 416 pulls down the voltage level in node Q to release the accumulated charge according to the second start pulse signal STV2 before the (m−2)^{th} gate driver unit 102ₘ₋₂ is driven.

Accordingly, when the gate driver 102 is controlled to forward scan the scan lines, please refer to FIG. 2A and FIG. 4B, the third clock signal CK3, the fourth clock signal CK4, the first clock signal CK1, the second clock signal CK2, and the second start pulse signal STV2 are sequentially transferred to the (m−2)^{th} gate driver unit 102ₘ₋₂. First, the second start pulse signal STV2 is in a low-level state. Therefore, the third pull-down circuit 416 is not in an operation state. The scan signal SG395 is transferred to the second pull-down circuit 415 to release the accumulated charge in node Q before the (m−2)^{th} gate driver unit 102ₘ₋₂ is driven. Next, the third clock signal CK3 and the scan signal SG395 are transferred to the first pull-up circuit 411. The first pull-up circuit 411 outputs the scan signal SG397 to the node Q to pull up the voltage level in node Q. Then, the fourth clock signal CK4 is transferred to the output circuit 413. The fourth clock signal CK4 is outputted form the output circuit 413 to the scan line G398 to serve as the scan signal SG398 according to the pulled up voltage level in node Q. The second pull-up circuit 412 receives the scan signal SG399 to keep the voltage level in node Q. Finally, the second clock signal CK2 is transferred to the first pull-down circuit 414 to pull down the scan signal SG398.

When the gate driver 102 is controlled to reverse scan the scan lines, please refer to FIG. 2B and FIG. 4B, the second start pulse signal STV2, the second clock signal CK2, the first clock signal CK1, the fourth clock signal CK4 and the third clock signal CK3 are sequentially transferred to the (m−2)^{th} gate driver unit 102ₘ₋₂. First, the third pull-down circuit 416 receives the second start pulse signal STV2 to release the accumulated charge in node Q before the (m−2)^{th} gate driver unit 102ₘ₋₂ is driven. Next, the second clock signal CK2 is transferred to the first pull-down circuit 414 to pull down the scan signal SG398. Then, the first clock signal CK1 and the scan signal SG399 are transferred to the second pull-up circuit 412. The second pull-up circuit 412 outputs the scan signal SG399 to the node Q to pull up the voltage level in node Q. The fourth clock signal CK4 is transferred to the output circuit 413. The fourth clock signal CK4 is outputted form the output circuit 413 to the scan line G398 to serve as the scan signal SG398 according to the pulled up voltage level in node Q. Then, the first pull-up circuit 411 receives the scan signal SG397 to keep the voltage level in node Q. Finally, the scan signal SG395 is transferred to the second pull-down circuit 415 to release the accumulated charge in node Q.

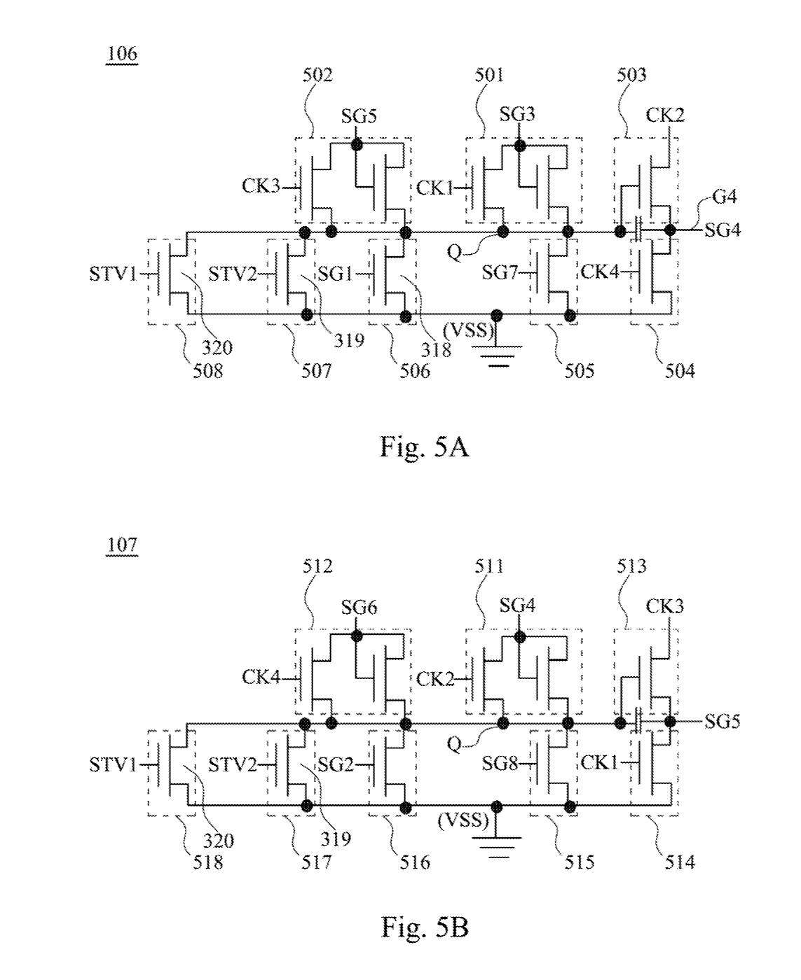

FIG. 5A illustrates a schematic diagram of the fourth gate driver unit 102₄. The fourth gate driver unit 102₄ includes a first pull-up circuit 501, a second pull-up circuit 502, an output circuit 503, a first pull-down circuit 505, a second pull-down circuit 505, a third pull-down circuit 506, a fourth pull-down circuit 507 and a fifth pull-down circuit 508. The circuit structures of the first pull-up circuit 501, the second pull-up circuit 502, the output circuit 503, the first pull-down circuit 504 and the second pull-down circuit 505 in the fourth gate driver unit 102₄ are same as that of the first pull-up circuit 301, the second pull-up circuit 302, the output circuit 303, the first pull-down circuit 304 and the second pull-down circuit 305 in the first gate driver unit 102₁ respectively. The main different point is that the fourth gate driver units 102₄ further includes the third pull-down circuit 506, the fourth pull-down circuit 507 and a fifth pull-down circuit 508. The third pull-down circuit 506 is used to receive the scan signal SG1 to pull down the voltage level in node Q to release the accumulated charge before the scan signal SG4 is generated during reverse scanning process. The fourth pull-down circuit 507 is used to receive the second start pulse signal STV2 to pull down the voltage level in node Q to release the accumulated charge before the scan signal SG4 is generated during reverse scanning process. The fifth pull-down circuit 508 is used to receive the first start pulse signal STV1 signal SG1 to pull down the voltage level in node Q to release the accumulated charge before the scan signal SG4 is generated during forward scanning process.

The third pull-down circuit 506 includes a eighth switch 318. The source electrode of the eighth switch 318 is coupled with the node Q. The gate electrode of the eighth switch 318 receives the scan signal SG 1. The drain electrode of the eighth switch 318 is coupled with the ground or the voltage Vss. When the scan signal SG1 turns on the eighth switch 318, the accumulated charge is released through the eighth switch 318. The fourth pull-down circuit 507 includes a ninth switch 319. The source electrode of the ninth switch 319 is coupled with the node Q. The gate electrode of the ninth switch 319 receives the second start pulse signal STV2. The drain electrode of the ninth switch 319 is coupled with the ground or the voltage Vss. When the second start pulse signal STV2 turns on the ninth switch 319, the accumulated charge is released through the ninth switch 319. The fifth pull-down circuit 508 includes a tenth switch 320. The source electrode of the tenth switch 320 is coupled with the node Q. The gate electrode of the tenth switch 320 receives the first start pulse signal STV1. The drain electrode of the tenth switch 320 is coupled with the ground or the voltage Vss. When the first start pulse signal STV1 turns on the tenth switch 320, the accumulated charge is released through the tenth switch 320.

Moreover, the first pull-up circuit 501 is coupled with a node Q to receive a scan signal SG3 from the third gate driver unit 102₃ to pull up the voltage level in node Q. The second pull-up circuit 502 is coupled with the node Q to receive the scan signal SG5 from the next stage gate driver unit to keep the voltage level in node Q. The output circuit 503 is coupled with the scan line G4 to receive the second clock signal CK2. The output circuit 503 outputs the second clock signal CK2 to the scan line G4 according to the voltage level in node Q to serve as the scan signal SG4. The first pull-down circuit 504 pulls down the scan signal SG4 according to the fourth clock signal CK4. The second pull-down circuit 505 pulls down the voltage level in node Q to release the accumulated charge according to the scan signal SG7 outputted by the gate driver unit 102₇.

Accordingly, when the gate driver 102 is controlled to forward scan the scan lines, please refer to FIG. 2A and FIG. 5A, the first start pulse signal STV1, the third clock signal CK3, the fourth clock signal CK4, the first clock signal CK1, the second clock signal CK2 and the second start pulse signal STV2 are sequentially transferred to the fourth gate driver unit 102₄. The fifth pull-down circuit 508 receives the first start pulse signal STV1. The third pull-down circuit 506 receives the scan signal SG1 to pull down the voltage level in node Q to release the accumulated charge before the fourth gate driver unit 102₄ is driven. Next, the third clock signal CK3 and the scan signal SG5 are transferred to the second pull-up circuit 502. At this time, the scan signal SG5 is in a low-level state. Therefore, the voltage level in the node Q is also in a low-level state. Next, the fourth clock signal is transferred to the first pull-down circuit 504 to ensure that no signal is outputted to the scan line G4 before the scan signal SG4 is generated. Next, the first pull-up circuit 501 receives the scan signal SG3 from the previous gate driver unit to pull up the voltage level in node Q. Then, the second clock signal CK2 is transferred to the output circuit 503. The second clock signal CK2 is outputted form the output circuit 503 to the scan line G4 to serve as the scan signal SG4 according to the pulled up voltage level in node Q. The scan signal SG4 is also transferred to the gate driver unit 102₅. Finally, the scan signal SG7 is transferred to the second pull-down circuit 505 to release the accumulated charge in node Q.

On the other hand, when the gate driver 102 is controlled to reverse scan the scan lines, the second start pulse signal STV2, the second clock signal CK2, the first clock signal CK1, the fourth clock signal CK4, the third clock signal CK3 and the first start pulse signal STV1 are sequentially transferred to the gate driver unit 102₄. Please refer to the FIG. 2B and FIG. 5A. First, the fourth pull-down circuit 507 receives the second start pulse signal STV2 and the second pull-down circuit 505 receives the scan signal SG7 to pull down the voltage level in node Q to release the accumulated charge before the gate driver unit 102₄ is driven. Next, the scan signal SG5 is transferred to the second pull-up circuit 502 to pull up the voltage level in node Q. Next, the second clock signal CK2 is transferred to the output circuit 503. The second clock signal CK2 is outputted form the output circuit 503 to the scan line G4 to serve as the scan signal SG4 according to the pulled up voltage level in node Q. The first pull-up circuit 501 receives the scan signal SG3 to keep the voltage level in node Q. Then, the fourth clock signal CK4 is transferred to the first pull-down circuit 504 to pull down the scan signal SG4. Finally, the second pull-up circuit 503 outputs the scan signal SG5 to the node Q according to the third clock signal CK3. Because the scan signal SG5 is in a low level state, the voltage level in node Q is pulled down to release the accumulated charge.

FIG. 5B illustrates a schematic diagram of the fifth gate driver unit 102₅. The fifth gate driver unit 102₅ and the fourth gate driver unit 102₄ have the same circuit structure. The fifth gate driver unit 102₅ includes a first pull-up circuit 511, a second pull-up circuit 512, an output circuit 513, a first pull-down circuit 515, a second pull-down circuit 515, a third pull-down circuit 516, a fourth pull-down circuit 517 and a fifth pull-down circuit 518. The first pull-up circuit 511 is coupled with a node Q to receive a scan signal SG4 from the previous gate driver unit to pull up the voltage level in node Q. The second pull-up circuit 512 is coupled with the node Q to receive the scan signal SG4 from the next stage gate driver unit to keep the voltage level in node Q. The output circuit 513 is coupled with the scan line G5 to receive the third clock signal CK3. The output circuit 503 outputs the third clock signal CK3 to the scan line G5 according to the voltage level in node Q to serve as the scan signal SG5. The first pull-down circuit 514 pulls down the scan signal SG5 according to the first clock signal CK1. The second pull-down circuit 515 pulls down the voltage level in node Q to release the accumulated charge according to the scan signal SG8 outputted by the gate driver unit 102₈. The third pull-down circuit 516 is used to receive the scan signal SG2 to pull down the voltage level in node Q to release the accumulated charge after the fifth gate driver unit 102₅ is driven to generate the scan signal SG5 during reverse scanning process. The fourth pull-down circuit 517 is used to receive the second start pulse signal STV2 to pull down the voltage level in node Q to release the accumulated charge before the scan signal SG5 is generated during reverse scanning process. The fifth pull-down circuit 518 is used to receive the first start pulse signal STV1 to pull down the voltage level in node Q to release the accumulated charge before the scan signal SG5 is generated during forward scanning process.

Accordingly, the gate driver receives four clock signals that are triggered in different times to forward or reverse scan the scan lines to reach bi-scanning effect.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A gate driver, used to drive a plurality of scan lines, a first scan line to a m^{th} scan line wherein the m is a positive integer, the gate driver comprising:
a plurality of driver units, a first driver unit to a m^{th} driver unit, coupled with the first scan line to the m^{th} scan line respectively, wherein the driver units generate a plurality of scan signals, a first scan signal to a m^{th} scan signal, to drive the first scan line to the m^{th} scan line respectively;
wherein the first driver unit, a second driver unit, a (m−1)^{th} driver unit and the m^{th} driver unit have same circuit structure,
a third driver unit and a (m−2)^{th} driver unit have same circuit structure, and
a fourth driver unit and a (m−3)^{th} driver unit have same circuit structure.

2. The gate driver of claim 1, further comprising:
a first start pulse signal, a second start pulse signal, a first clock signal, a second clock signal, a third clock signal and a fourth clock signal transferring to the gate driver units,
wherein each of the first start pulse signal and the second start pulse signal is a pulse signal with a pulse width of T/2, and
each of the first clock signal, the second clock signal, the third clock signal and the fourth clock signal has a period of T.

3. The gate driver of claim 2, wherein when the gate driver is controlled to forward scan the scan lines, the first start pulse signal, the third clock signal, the fourth clock signal, the first clock signal and the second clock signal are sequentially generated, and
wherein the third clock signal is generated at T/4 behind the first start pulse signal being generated, and the fourth clock signal is generated at T/4 behind the third clock signal being generated, and the first clock signal is generated at T/4 behind the fourth clock signal being generated, and the second clock signal is generated at T/4 behind the first clock signal being generated.

4. The gate driver of claim 2, wherein when the gate driver is controlled to reverse scan the scan lines, the second start pulse signal, the second clock signal, the first clock signal, the fourth clock signal and the third clock signal are sequentially generated, and
wherein the second clock signal is generated at T/4 behind the second start pulse signal being generated, and the first clock signal is generated at T/4 behind the second clock signal being generated, and the fourth clock signal is generated at T/4 behind the first clock signal being generated, and the third clock signal is generated at T/4 behind the fourth clock signal being generated.

5. The gate driver of claim 2, wherein each of the first driver unit, the second driver unit, the (m−1)^{th} driver unit and the m^{th} driver unit further comprises:
a first pull-up circuit coupled between a node and a first signal, wherein the first pull-up circuit changes a voltage level of the node according to the first signal and a second signal;
a second pull-up circuit coupled between the node and a third signal, wherein the second pull-up circuit changes a voltage level of the node according to the third signal and a fourth signal;
an output circuit coupled with a scan line and a fifth signal, wherein the output circuit outputs the fifth signal to serve as a scan signal according to the changed voltage level in the node;
a first pull-down circuit coupled between the scan line and a low-level voltage, wherein the first pull-down circuit pulls down a voltage of the scan line to the low-level voltage according to a sixth signal; and
a second pull-down circuit coupled between the node and the low-level voltage, wherein the second pull-down circuit pulls down a voltage of the node to the low-level voltage according to a seventh signal.

6. The gate driver of claim 2, wherein each of the third driver unit and the (m−2)^{th} driver unit further comprises:
a first pull-up circuit coupled between a node and a first signal, wherein the first pull-up circuit changes a voltage level of the node according to the first signal and a second signal;
a second pull-up circuit coupled between the node and a third signal, wherein the second pull-up circuit changes a voltage level of the node according to the third signal and a fourth signal;
an output circuit coupled with a scan line and a fifth signal, wherein the output circuit outputs the fifth signal to serve as a scan signal according to the changed voltage level in the node;
a first pull-down circuit coupled between the scan line and a low-level voltage, wherein the first pull-down circuit pulls down a voltage of the scan line to the low-level voltage according to a sixth signal;
a second pull-down circuit coupled between the node and the low-level voltage, wherein the second pull-down circuit pulls down a voltage of the node to the low-level voltage according to a seventh signal; and
a third pull-down circuit coupled between the node and the low-level voltage, wherein the third pull-down circuit pulls down a voltage of the node to the low-level voltage according to a eighth signal.

7. The gate driver of claim 2, wherein each of the fourth driver unit and the (m−3)^{th} driver unit further comprises:
a first pull-up circuit coupled between a node and a first signal, wherein the first pull-up circuit changes a voltage level of the node according to the first signal and a second signal;
a second pull-up circuit coupled between the node and a third signal, wherein the second pull-up circuit changes a voltage level of the node according to the third signal and a fourth signal;
an output circuit coupled with a scan line and a fifth signal, wherein the output circuit outputs the fifth signal to serve as a scan signal according to the changed voltage level in the node;
a first pull-down circuit coupled between the scan line and a low-level voltage, wherein the first pull-down circuit pulls down a voltage of the scan line to the low-level voltage according to a sixth signal;
a second pull-down circuit coupled between the node and the low-level voltage, wherein the second pull-down circuit pulls down a voltage of the node to the low-level voltage according to a seventh signal;
a third pull-down circuit coupled between the node and the low-level voltage, wherein the third pull-down circuit pulls down a voltage of the node to the low-level voltage according to a eighth signal;
a fourth pull-down circuit coupled between the node and the low-level voltage, wherein the fourth pull-down circuit pulls down a voltage of the node to the low-level voltage according to a ninth signal; and
a fifth pull-down circuit coupled between the node and the low-level voltage, wherein the fifth pull-down circuit pulls down a voltage of the node to the low-level voltage according to a tenth signal.

8. The gate driver of claim 5, wherein the second signal is a h^{th} clock signal, wherein h=1+mod(n/4),
the fourth signal is a i^{th} clock signal, wherein i=1+mod((n+2)/4),
the fifth signal is a j^{th} clock signal, wherein j=1+mod((n+1)/4), and
the sixth signal is a k^{th} clock signal, wherein k=1+mod((n+3)/4),
wherein n=1 to m.

9. The gate driver of claim 8, wherein the first signal is the first start pulse signal, the third signal is the second scan signal and the seventh signal is the fourth scan signal in the first driver unit.

10. The gate driver of claim 8, wherein the first signal is the first scan signal, the third signal is the third scan signal and the seventh signal is the fifth scan signal in the second driver unit.

11. The gate driver of claim 8, wherein the first signal is the second scan signal, the third signal is the fourth scan signal and the seventh signal is the sixth scan signal and the eighth signal is the first start pulse signal in the third driver unit.

12. The gate driver of claim 8, wherein the first signal is a (n−1)^{th} scan signal, the third signal is a (n+1)^{th} scan signal, the seventh signal is a (n+3)^{th} scan signal, the eighth signal is a (n−3)^{th}, the ninth signal is the second start pulse signal and the tenth signal is the first start pulse signal in the fourth driver unit to the (m−3)^{th} driver unit, wherein n=4 to (m−3).

13. The gate driver of claim 8, wherein the first signal is a (m−3)^{th} scan signal, the third signal is a (m−1)^{th} scan signal, the seventh signal is a (m−5)^{th} scan signal and the eighth signal is the second start pulse signal in the (m−2)^{th} driver unit.

14. The gate driver of claim 8, wherein the first signal is a (m−2)^{th} scan signal, the third signal is the (m)^{th} scan signal and the seventh signal is a (m−4)^{th} scan signal in the (m−1)^{th} driver unit.

15. The gate driver of claim 8, wherein the first signal is a (m−1)^{th} scan signal, the third signal is a (m+1)^{th} scan signal and the seventh signal is a (m−3)^{th} scan signal in the (m)^{th} driver unit.

16. The gate driver of claim 5, wherein the first pull-up circuit further comprises:
a first switch, wherein a gate electrode and a source electrode of the first switch is connected together to receives the first signal and a drain electrode of the first switch is coupled to the node; and
a second switch, wherein a source electrode of the second switch is connected to the source electrode of the first switch, a gate electrode of the second switch receives the second signal and a drain electrode of the second switch is coupled to the node.

17. The gate driver of claim 16, wherein the second pull-up circuit further comprises:
a third switch, wherein a gate electrode and a source electrode of the third switch is connected together to receives the third signal and a drain electrode of the third switch is coupled to the node; and
a fourth switch, wherein a source electrode of the fourth switch is connected to the source electrode of the third switch, a gate electrode of the fourth switch receives the fourth signal and a drain electrode of the fourth switch is coupled to the node.

18. The gate driver of claim 17, wherein the output circuit further comprises:
a fifth switch, wherein a source electrode of the fifth switch receives the fifth signal, a gate electrode of the fifth switch is coupled with the node and a drain electrode of the fifth switch is coupled with the scan line.

19. The gate driver of claim 18, wherein the first pull-down circuit further comprises:
a sixth switch, wherein a source electrode of the sixth switch is coupled with the scan line, a gate electrode of the sixth switch receives the sixth signal and a drain electrode of the sixth switch is coupled with the low-level voltage.

20. The gate driver of claim 19, wherein the second pull-down circuit further comprises:
a seventh switch, wherein a source electrode of the seventh switch couples with the node, a gate electrode of the seventh switch receives the seventh signal and a drain electrode of the seventh switch is coupled with the low-level voltage.

21. The gate driver of claim 20, wherein the third pull-down circuit further comprises:
an eighth switch, wherein a source electrode of the eighth switch is coupled with the node, a gate electrode of the eighth switch receives the eighth signal and a drain electrode of the eighth switch is coupled with the low-level voltage.

22. The gate driver of claim 21, wherein the fourth pull-down circuit further comprises:
a ninth switch, wherein a source electrode of the ninth switch is coupled with the node, a gate electrode of the ninth switch receives the ninth signal and a drain electrode of the ninth switch is coupled with the low-level voltage.

23. The gate driver of claim 22, wherein the fifth pull-down circuit further comprises:
a tenth switch, wherein a source electrode of the tenth switch is coupled with the node, a gate electrode of the tenth switch receives the tenth signal and a drain electrode of the tenth switch is coupled with the low-level voltage.
